(19) United States
(12) Patent Application Publication
(10) Pub. No.: US 2021/0148316 A1
(43) Pub. Date: May 20, 2021

(54) FUEL INJECTION VALVE

(71) Applicant: HITACHI AUTOMOTIVE SYSTEMS, LTD., Hitachinaka-shi, Ibaraki (JP)

(72) Inventors: Atsushi NAKAI, Hitachinaka-shi, Ibaraki (JP); Masaki NAGAOKA, Hitachinaka-shi, Ibaraki (JP); Shigeo KUBA, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/622,205

(22) PCT Filed: Mar. 26, 2018
(86) PCT No.: PCT/JP2018/011959

§ 371 Date: Dec. 12, 2019

(30) Foreign Application Priority Data
Jun. 16, 2017 (JP) 2017-118670

(51) Int. Cl. F02M 51/06; F02M 61/18

(52) U.S. Cl. CPC F02M 51/0682; F02M 2200/8084; F02M 61/188; F02M 61/1853

(57) ABSTRACT

This fuel injection valve is provided with: a valve seat (15b) and a valve body (27c), which cooperate to open and close a fuel passage; a valve seat member (15) having formed thereon the valve seat (15b) and a guide surface (15c) which guides the valve body (27c); and a cylindrical body (5) having the valve seat member (15) press-fitted in the front end-side end thereof. The valve seat member (15) is configured so that the press-fit section (15f) thereof which is press-fitted in the cylindrical body (5) is provided at a position offset toward the base end of the cylindrical body (5) relative to both the valve seat (15b) and the guide surface (15c) in the direction of the center axis (1x) of the fuel injection valve.

### TECHNICAL FIELD

This invention relates to a fuel injection valve arranged to inject a fuel.

### BACKGROUND ART

Japanese Patent Application Publication No. 2013-164027 (patent document 1) has been known as a background art of this technical field. This fuel injection valve includes a nozzle; a fixed valve that is press-fit in a tip end of the nozzle, and that includes a fuel injection hole from which a fuel is injected; and a movable member which is arranged to be abutted on the fixed valve to form a fuel seal portion, and which is arranged to open and close the fuel injection hole (cf. abstract). Moreover, in this fuel injection valve, the press-fit portion of the fixed valve with respect to the nozzle is provided in a range in which the press-fit portion is overlapped with at least one of the guide portion (guide member) arranged to guide the movable member, and a fixed valve side seat surface formed on the fixed valve, in a direction along an axis of the movable member (cf. FIGS. 2, 8, 11, 12, 14, and 15). That is, the fixed valve side seat surface, the guide portion, and the press-fit portion of the fixed valve are projected to an imaginary plane which is parallel to the axis of the movable member, and which includes the axis, the fixed valve side seat surface, the guide portion, and the press-fit portion of the fixed valve are overlapped with one another on this imaginary plane.

### Prior Art Document

### Patent Document

Patent Document 1: Japanese Patent Application Publication No. 2013-164027

### SUMMARY OF THE INVENTION

### Problems Which the Invention is intended to Solve

In the fuel injection valve, it is required that an oil-tight characteristic to seal the fuel is improved at the seal portion at which the fixed valve side seat surface and the movable member are abutted on each other, and that a center axis of the guide portion arranged to guide the movable member corresponds to a center axis of the fixed valve side seat surface at the high accuracy.

In below-described explanations, the nozzle, the fixed valve, the fixed valve side seat surface, and the movable member are referred to, respectively, as a cylindrical member, a valve seat member, a valve seat, and a valve element.

In the fuel injection valve, in a case where the press-fit portion of the valve seat member with respect to the cylindrical member is overlapped with at least one of the guide portion of the valve, and the valve seat in the direction along the axis of the valve element, the roundness of the valve seat may be deteriorated, and a distortion may be generated in the guide portion (the guide surface) when the valve seat member is press-fit in the cylindrical member. However, the patent document 1 does not take sufficient consideration for the above-problems.

It is, therefore, an object of the present invention to provide a fuel injection valve which includes a cylindrical member, and a valve seat member press-fit in the cylindrical member, and which is devised to suppress a deterioration of a roundness of the valve seat, and a distortion of a guide portion (guide surface).

### Means for Solving the Problem

For attain the above-described objects, a fuel injection valve according to the present invention comprises: a valve seat and a valve element which are cooperated to open and close a fuel passage; a valve seat member to which the valve seat and a guide surface arranged to guide the valve element are formed; and a cylindrical member including an end portion which is on a tip end side, and in which the valve seat member is press-fit, the valve seat member including a press-fit portion which is press-fit in the cylindrical member, and which is located at a position apart from the valve seat and the guide surface on a base end side of the valve seat and the guide surface in a direction along a center axis of the fuel injection valve.

### Benefit of the Invention

In the present invention, in a fuel injection valve which includes a cylindrical member, and a valve seat member press-fit in the cylindrical member, it is possible to suppress a deterioration of a roundness of the valve seat, and a distortion of a guide portion (guide surface).

### BRIEF DESCRIPTION OF DRAWINGS

FIG. 1 is a sectional view showing a section along a valve axis (center axis) in a fuel injection valve according to one embodiment of the present invention.

FIG. 2 is an enlarged sectional view showing a portion near a movable member 27 shown in FIG. 1.

FIG. 3 is an enlarged sectional view showing a portion near a nozzle portion 8 shown in FIG, 2.

FIG. 4 is a sectional view showing a press-fit portion of the valve seat member 15 in the one embodiment of the present invention.

FIG. 5 is a sectional view showing the press-fit portion of the valve seat member 15 in a comparative example with respect to the present invention.

FIG. 6 is a view showing a relationship between size variations of the components, and the press-fit length of the valve seat member 15.

FIG. 7 is a sectional view showing a press-fit portion of the valve seat member 15 according to the variation (first variation) of the embodiment of the present invention.

FIG. 8 is a sectional view showing a press-fit portion of the valve seat member 15 according to the variation (second variation) of the embodiment of the present invention.

FIG. 9 is a sectional view showing an internal combustion engine on which the fuel injection valve 1 is mounted.

### Description of Embodiments

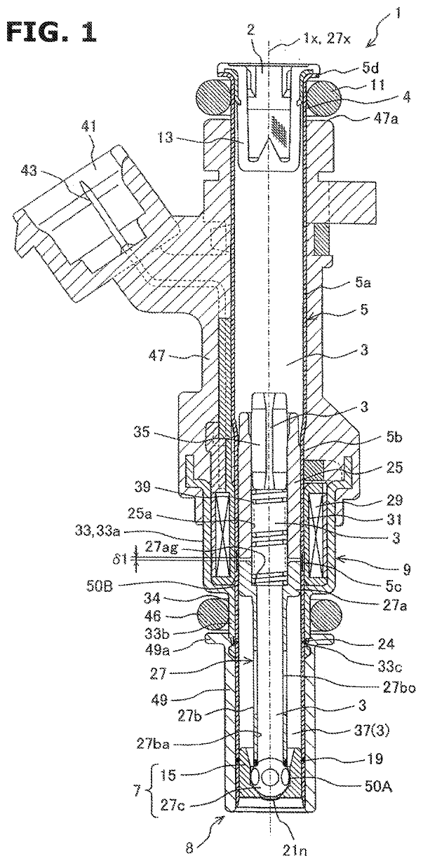

One embodiment according to the present invention are explained with reference to FIG. 1 to FIG. 3.

An overall configuration of a fuel injection valve 1 is explained with reference to FIG. 1. FIG. 1 is a sectional view showing a section along a valve axis (center axis), in the fuel injection valve according to an embodiment of the present invention. A symbol 1x shows the center axis of the fuel injection valve 1. An axis (valve axis) 27x of a movable member 27 is disposed to correspond to the center axis. The axis (valve axis) 27x corresponds to the center axes of a cylindrical member 5 and a valve seat member 15.

In FIG. 1, an upper end portion (upper end side) of the fuel injection valve 1 may be referred to as a base end portion (base end side). A lower end portion (lower end side) of the fuel injection valve 1 may be referred to as a tip end portion (tip end side). The way of calling the base end portion (the base end side) and the tip end portion (the tip end side) are based on a flow direction of the fuel, or a mounting structure of the fuel injection valve 1 with respect to fuel pipes. Moreover, the upward and downward directions in the specification are based on FIG. 1. The upward and downward directions in the specification do not relate to upward and downward directions when the fuel injection valve 1 is mounted to an internal combustion engine.

Fuel injection valve 1 includes a cylindrical member S made from the metal; and a fuel flow passage (fuel passage) 3 which is formed in the cylindrical member 5, and which extends substantially along the central axis 1a. The cylindrical member 5 is made from metal material such as a stainless having magnetism. The cylindrical member 5 has a stepped shape along the central axis 1a by the press processing such as the deep drawing. With this, the cylindrical member 5 includes a first end portion (a large diameter portion 5a side) having a diameter larger than a diameter of a second end portion (a small diameter portion 5b side).

A fuel supply opening 2 is provided to the base end portion of the cylindrical member 5. At this fuel supply opening 2, there is provided a fuel filter 13 arranged to remove foreign particle mixed in the fuel.

The base end portion of the cylindrical member 5 includes a flange portion (large diameter portion) 5d which is bent in the radially outward direction to increase the diameter. An O-ring 11 is disposed in an annular recessed portion (annular groove portion) 4 formed by the flange portion 5d and a base end side end portion 47a of a cover 47.

A valve section 7 is constituted in the tip end portion of the cylindrical member 5. The valve section 7 includes a valve element 27c and a valve seat member 15. The valve seat member 15 is press-fit in the inner circumference side of the tip end portion of the cylindrical member 5. The valve seat member 15 is fixed to the cylindrical member 5 by the laser welding. The laser welding is performed to an overall circumference of the cylindrical member 5 from the outer circumference side of the cylindrical member 5.

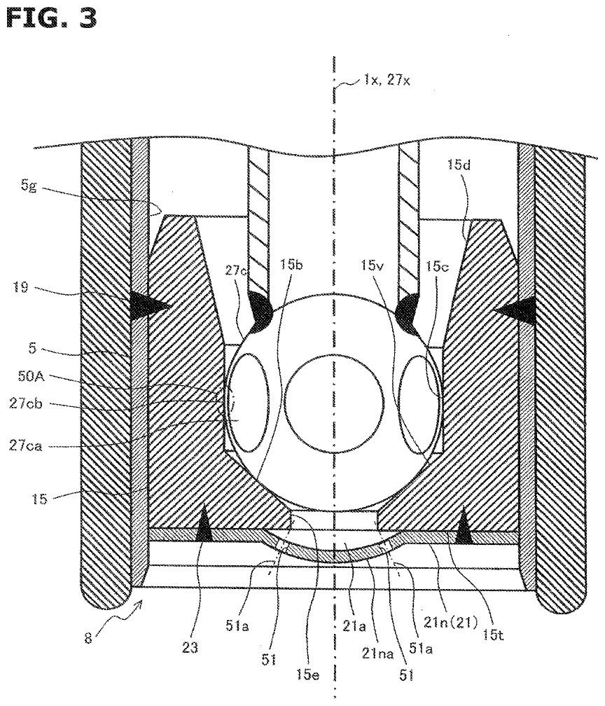

A nozzle plate 21n is fixed to the valve seat member 15. The valve seat member 15 and the nozzle plate 21n constitute a nozzle section 8. The valve seat member 15 is inserted and fixed in the inner circumference surface 5g (cf. FIG. 3) of the cylindrical member 5, so that the valve seat member 15 and the nozzle plate 21n are assembled to the tip end side of the cylindrical member 5,

The cylindrical member 5 according to this embodiment is constituted by one member from a portion to which the fuel supply opening 2 is provided, to a portion to which the valve seat member 15 and the nozzle plate 21n are fixed. The tip end side portion of the cylindrical member 5 constitutes a nozzle holder arranged to hold the nozzle section 8. In this embodiment, the nozzle holder is constituted by the one member with the base end side portion of the cylindrical member 5.

A drive section 9 is disposed at an intermediate portion of the cylindrical member 5. The drive section 9 is arranged to drive the valve element 27c. The drive section 9 is constituted by an electromagnetic actuator (electromagnetic drive section).

In particular, the drive section 9 includes a fixed iron core 25 fixed in the inside (on the inner circumference side) of the cylindrical member 5; a movable member 27 which is disposed within the cylindrical member 5, on the tip end side of the fixed iron core 25; an electromagnetic coil 29 mounted on an outer circumference side of the cylindrical member 5; and a yoke 33 which covers the electromagnetic coil 29 on the outer circumference side of the electromagnetic coil 29.

The movable member 27 is provided by integrating the valve element 27c, the rod portion (the connection portion) 27b, and the movable iron core 27a. The movable member 27 includes a movable iron core (movable core) 27a which is located on the base end side, and which confronts the fixed iron core 25. The movable member 27 is assembled to be movable in a direction along the center axis 1x. The electromagnetic coil 29 is disposed on the outer circumference side at a position at which the fixed iron core 25 and the movable iron core 27a confront each other through a minute gap δ1. With this, the movable iron core 27a and the fixed iron core 25 act the electromagnetic force between the movable iron core 27a and the fixed iron core 25, so as to drive the valve element 27a.

The movable member 27 and the fixed iron core 25 are received within the cylindrical member 5. The cylindrical member 5 is abutted on the fixed iron core 25. The cylindrical member 5 confronts the outer circumference surface of the movable iron core 27a to constitute a housing surrounding the movable iron core 27a and the fixed iron core 25. That is, the cylindrical member 5 receives the movable iron core 27a and the fixed iron core 25.

The movable iron core 27a, the fixed iron core 25, and the yoke 33 constitute a closed magnetic path in which the magnetic flux generated by energizing the electromagnetic coil 29 flows. Although the magnetic flux passes through the minute gap δ1, a nonmagnetic portion or a weak (feeble) magnetic portion having magnetism weaker than that of other portions of the cylindrical member 5 is provided at a position corresponding to the minute gap δ1 of the cylindrical member 5 so as to decrease the magnetic flux leakage flowing in the cylindrical member 5 at the minute gap δ1. Hereinafter, this nonmagnetic portion or the weak magnetic portion is referred to merely as nonmagnetic portion 5c.

The electromagnetic coil 29 is wound around a bobbin 31 made from resin material into a cylindrical shape. The electromagnetic coil 29 is mounted on the outer circumference side of the cylindrical member 5. The electromagnetic coil 29 is electrically connected to a terminal 43 provided to a connector 41. The connector 41 is connected to an outer drive circuit (not shown) to apply the drive current to the electromagnetic coil 29 through the terminal 43.

The fixed iron core 25 is made from the magnetic metal material. The fixed iron core 25 is formed into a cylindrical shape. The fixed iron core 25 includes a through hole 25a which penetrates through the central portion of the fixed iron core 25 in a direction along the center axis 1x. The through hole 25a constitutes a fuel passage (upstream side fuel passage) 3 on the upstream side of the movable iron core 27a. The fixed iron core 25 is fixed on the base end portion of the small diameter portion 5b of the cylindrical member 5 by the press-fit. The fixed iron core 25 is positioned at an intermediate portion of the cylindrical member 5. The large diameter portion 5a is provided on the base end side of the small diameter portion 5b. With this, it is possible to ease the assembly operation of the fixed iron core 25. The fixed iron core 25 may be fixed to the cylindrical member 5 by the welding. Moreover, the fixed iron core 25 may be fixed to the cylindrical member 5 by using both the welding and the press-fit.

The movable iron core 27a is an annular member. The valve element 27c is a member arranged to be abutted on a valve seat 15b (cf. FIG. 3). The valve element 27c is arranged to open and close the fuel passage on the upstream side of the fuel injection hole 51 in cooperation with the valve seat 15b. The rod portion 27b has a long and narrow cylindrical shape. The rod portion 27b is a connection portion connecting the movable iron core 27a and the valve element 27c. The movable iron core 27a is connected to the valve element 27c. The movable iron core 27a is arranged to drive the valve element 27c in the valve opening direction or the valve closing direction by the magnetic attraction force acted between the fixed iron core 25 and the movable iron core 27a.

In this embodiment, the movable iron core 27a is fixed to the rod portion 27b. However, the movable iron core 27a may be connected to the rod portion 27b so as to be moved relative to the rod portion 27b.

In this embodiment, the rod portion 27b and the valve element 27c are constituted by different members. The valve element 27c is fixed to the rod portion 27b. The rod portion 27b and the valve element 27c are fixed by the press-fit or the welding. The rod portion 27b and the valve element 27c may be integrally constituted by one member.

The rod portion 27b has a cylindrical shape. The rod portion 27b includes a hole 27ba which includes an upper end opened to the lower end portion of the movable iron core 27a, and which extends in the axial direction. The rod portion 27b includes a connection hole (opening portion) 27bo connecting the inside (the inner circumference side) and the outside (the outer circumference side). A fuel chamber 37 is formed between the outer circumference surface of the rod portion 27b and the inner circumference surface of the cylindrical member 5.

A spring member 39 is provided in the through hole 25a of the fixed iron core 25. In this embodiment, the spring member is constituted by a coil spring 39. In below-explanations, the spring member is referred to as the coil spring 39.

One end of the coil spring 39 is abutted on a spring seat 27ag provided inside the movable iron core 27a. The other end of the coil spring 39 is abutted on an adjuster (adjusting member) disposed within the through hole 25a of the fixed iron core 25. The coil spring 39 is disposed in a compressed state between the spring seat 27ag provided to the movable iron core 27a, and a lower end (tip end side end surface) of the adjuster (adjusting member) 35.

The coil spring 39 is an urging member arranged to urge the movable member 27 in a direction (the valve closing direction) in which the valve element 27c is abutted on the valve seat 15b. The urging force of the movable member 27 (that is, the valve element 27c) by the coil spring 39 is adjusted by adjusting the position of the adjuster 35 within the through hole 25a in the direction along the center axis 1x.

The adjuster 35 includes the fuel flow passage 3 which penetrates through the central portion of the adjuster 35 in the direction along the center axis 1x.

The fuel supplied from the fuel supply opening 2 flows in the fuel flow passage 3 of the adjuster 35. Then, the fuel flows in the fuel flow passage 3 of the tip end side portion of the through hole 25a of the fixed iron core 25, and flows in the fuel flow passage 3 constituted within the movable member 27.

The yoke 33 is made from the metal material having the magnetism. The yoke 33 also serves as the housing of the fuel injection valve 1. The yoke 33 is formed into a stepped cylindrical shape having a large diameter portion 33a and a small diameter portion 33b. The large diameter portion 33a has a cylindrical shape covering the outer circumference of the electromagnetic coil 29. The small diameter portion 33b having the diameter smaller than the diameter of the large diameter portion 33a. The small diameter portion 33b is formed on the tip end side of the large diameter portion 33a. The small diameter portion 33b is press-fit or mounted on the outer circumference of the small diameter portion 5b of the cylindrical member 5. With this, the inner circumference surface of the small diameter portion 33b is closely (tightly) contacted on the outer circumference surface of the cylindrical member 5. In this case, at least a part of the inner circumference surface of the small diameter portion 33b confronts the outer circumference surface of the movable iron core 27a through the cylindrical member 5, so as to decrease the magnetic resistance in the magnetic path formed at these confronting portions.

The yoke 33 includes an annular recessed portion 33c which is formed in the circumferential direction on the outer circumference surface of the tip end side end portion. A small thickness portion is formed on a bottom surface of the annular recessed portion 33c. At this small thickness portion of the annular recessed portion 33c, the yoke 33 and the cylindrical member 5 are jointed in the entire circumference by the laser welding.

A cylindrical protector 49 having a flange portion 49a is mounted on the tip end portion of the cylindrical member 5. The tip end portion of the cylindrical member 5 is protected by the protector 49. The protector 49 covers the laser welding portion 24 of the yoke 33.

The flange portion 49a of the protector 49, the small diameter portion 33b of the yoke 33, the stepped surface between the large diameter portion 33a and the small diameter portion 33b of the yoke 33 constitute an annular groove 34. An O-ring 46 is mounted on the annular groove 34. The O-ring 46 serves as a seal arranged to secure the liquid tightness and the air tightness between an inner circumference surface of an insertion opening formed in the internal combustion engine, and the outer circumference surface of the small diameter portion 33b of the yoke 33 when the fuel injection valve 1 is mounted to the internal combustion engine.

The resin cover 47 is molded from the intermediate portion of the fuel injection valve 1 to a portion near the base end side end portion of the fuel injection valve 1. The tip end side end portion of the resin cover 47 covers a part of the base end side of the large diameter portion 33a of the yoke 33. Moreover, the connector 41 is integrally formed by the resin forming the resin cover 47.

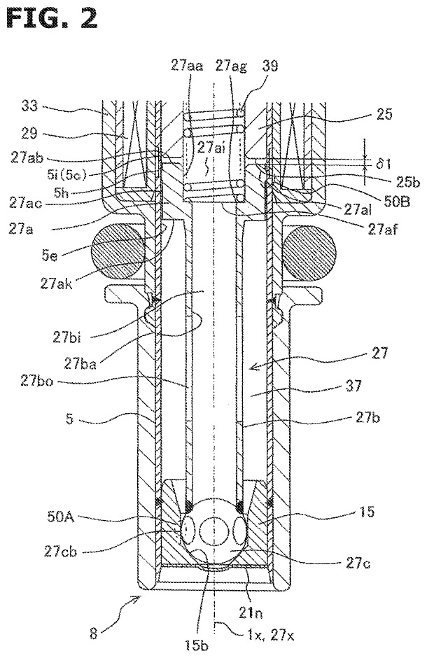

A configuration near the movable member 27 is explained in detail with reference to FIG. 2. FIG. 2 is an enlarged sectional view showing the configuration near the movable member 27 shown in FIG. 1.

In the embodiment, the movable iron core 27a and the rod portion 27b are integrally formed by one member.

The movable iron core 27a includes a recessed portion 27aa which is formed at a central portion of an upper end surface (upper end portion) 27ab, and which is recessed toward the lower end side. The spring seat 27ag is formed on a bottom portion of the recessed portion 27aa. One end (tip end side end portion) of the coil spring 39 is supported by the spring seat 27ag. Moreover, an opening portion 27af is formed on the spring seat 27ag of the recessed portion 27aa. The opening portion 27af is connected to the inside of the hole 27ba of the rod portion 27b. The opening portion 27af constitutes a fuel passage arranged to flow the fuel flowing from the through hole 25a of the fixed iron core 25 into a space 27ai within the recessed portion 27aa, to a space 27bi inside the hole 27ba of the rod portion 27b.

In this embodiment, the rod portion 27b and the movable iron core 27a are constituted by one member. However, the rod portion 27b and the movable iron core 27a may be constituted by integrally assembling different members.

The upper end surface (the base end side end surface) 27ab of the movable iron core 27a is an end surface which is positioned on the side of the fixed iron core 25, and which confronts the lower end surface (the tip end side end surface) 25b of the fixed iron core 25, The end surface of the movable iron core 27a which is opposite to the upper end surface 27ab is an end surface which is positioned on the tip end side (the nozzle side) of the fuel injection valve 1, and which is referred to as a lower end surface (lower end portion) 27ak hereinafter.

The upper end surface 27ab of the movable iron core 27a, and the lower end surface 25b of the fixed iron core 25 constitute magnetic attraction surfaces to which the magnetic attraction forces are acted to each other.

In this embodiment, the nonmagnetic portion 5c is provided on the outer circumference side of the magnetic attraction surfaces. The nonmagnetic portion 5c is constituted by an annular recessed portion 5h formed on the outer circumference surface of the cylindrical member 5. The nonmagnetic portion 5c is formed by decreasing a thickness of a portion corresponding to the nonmagnetic portion 5c. That is, the annular recessed portion 5h is formed by forming a small thickness portion 5i, in the circumferential direction, in a portion of the cylindrical member 5 that is positioned on the outer circumference portion of the confronting portion at which the movable iron core 27a and the fixed iron core 25 confront each other. The small thickness portion 5i has a thickness smaller than that of the other portions of the cylindrical member 5. With this, the magnetic resistance of the magnetic flux flowing in the small thickness portion 5i is increased so that the magnetic flux is difficult to flow. This nonmagnetic portion 5c may be formed by the demagnetization to have the same thickness as the other portions of the cylindrical member 5.

A sliding portion is constituted on the outer circumference surface 27ac of the movable iron core 27a. The sliding portion is arranged to be slidably moved on the inner circumference surface 5e of the cylindrical member 5. A raised portion 27a1 is formed as the sliding portion on the outer circumference surface 27ac. The raised portion 27a1 protrudes in the radially outward direction. The inner circumference surface 5e constitutes an upstream guide portion 50B on which the raised portions 27a1 of the movable iron core 27a is slidably abutted.

On the other hand, the valve seat member 15 includes a guide surface 15c (cf. FIG. 3) on which a spherical surface 27cb of the valve element 27c is slidably abutted. A guide portion by which the guide surface 15c guides the spherical surface 27cb constitutes a downstream side guide portion 50A. With this, the movable member 27 is arranged to be guided by two points of the upstream guide portion 50B and the downstream guide portion 50A, and to be reciprocated in the direction along the center axis 1x (in the valve opening and closing directions).

The rod portion 27b includes an opening portion (connection hole) 27bo connecting the inside (the hole 27ba) and the outside (the fuel chamber 37). The connection hole 27bo constitutes a fuel passage connecting the inside and the outside of the rod portion 27b. With this, the fuel within the through hole 25a of the fixed iron core 25 flows through the hole 27ba and the connection hole 27bo to the fuel chamber 37.

Next, a configuration of the nozzle section 8 is explained in detail with reference to FIG. 3. FIG. 3 is an enlarged sectional view showing a portion near the nozzle section 8 shown in FIG. 2.

The valve seat member 15 includes through holes (a diameter increasing portion 15d, the guide surface 15c, a conical surface 15v, and a fuel introduction hole 15e) which are formed to penetrate through the valve seat member 15 in the direction along the center axis 1x.

A conical surface (frustum surface) 15v is formed in the middle of this through holes (the diameter increasing portion 15d, the guide surface 15c, the conical surface 15v, and the fuel introduction hole 15e). This conical surface 15v has diameters decreased toward the downstream side. The valve seat 15b is constituted on the conical surface 15v. The valve element 27c is arranged to be abutted on and separated from the valve seat 15b, and thereby to open and close the fuel passage. Besides, the conical surface 15v on which the valve seat 15b is formed may be referred to as a valve seat surface.

Abutment portions on which the valve seat 15b and the valve element 27c are abutted each other constitute seal portions arranged to seal the fuel in the valve closing state. The abutment portion of the valve seat 15b may be referred to as a valve seat side (fixed valve side) seat portion. The abutment portion of the valve seat 27c may be referred to as a valve element side (movable valve side) seat portion.

In the through holes (the diameter increasing portion 15d, the guide surface 15c, the conical surface 15v, and the fuel introduction hole 15e), hole portions (the diameter increasing portion 15d, the guide surface 15c, and the conical surface 15v) on the upper side of the conical surface 15v constitute a valve element receiving hole receiving the valve element 27c. The guide surface 15c is formed on the inner circumference surface of the valve element receiving hole (the diameter increasing portion 15d, the guide surface 15c, and the conical surface 15v). The guide surface 15c is arranged to guide the valve element 27c in the direction along the center axis 1x. The guide surface 15c constitutes the downstream side guide section (downstream side guide surface) 50A in the two guide surfaces arranged to guide the movable member 27.

The diameter increasing portion 15d is formed on the upstream side of the guide surface 15c. The diameter increasing portion has a diameter increased toward the upstream side. The diameter increasing portion 15d constitutes a base end side opening portion which is positioned at an upper end portion of the through holes (the diameter increasing portion 15d, the guide surface 15c, the conical surface 15v, and the fuel introduction hole 15e), and which is opened to the fuel chamber 37. The diameter increasing portion 15d is constituted by a taper surface whose diameter are decreased from the base end side toward the tip end side. An inclination angle of this taper surface is acuter than an inclination angle of the valve seat surface described later.

A lower end portion of the through holes (the diameter increasing portion 15d, the guide surface 15c, and the conical surface 15v) is connected to the fuel introduction hole 15e. The lower end surface of the fuel introduction hole 15e is opened to the tip end surface 15t of the valve seat member 15. That is, the fuel introduction hole 15e constitutes a tip end side opening portion of the through holes (the diameter increasing portion 15d, the guide surface 15c, the conical surface 15v, and the fuel introduction hole 15e).

The nozzle plate 21n is mounted on the tip end surface 15t of the valve seat member 15. The nozzle plate 21n is fixed to the valve seat member 15 by the laser welding. The laser welding portion 23 makes a circle of the injection hole forming region in which the fuel injection hole 51 is formed, so as to surround the injection hole forming region.

Moreover, the nozzle plate 21n is constituted by a plate member (flat plate) having a uniform thickness. The nozzle plate 21n includes a protruding portion 21na which is formed at a central portion of the nozzle plate 21n, and which protrudes outwardly. The protruding portion 21na is formed by a curved surface (for example, spherical surface). A fuel chamber 21a is formed within the protruding portion 21na. This fuel chamber 21a is connected to the fuel introduction hole 15e formed in the valve seat member 15. The fuel is supplied through the fuel introduction hole 15e to the fuel chamber 21a.

The protruding portion 21na includes a plurality of fuel injection holes 51. Configurations of the fuel injection holes 110 are not specifically limited. A swirl chamber arranged to provide swirl force to the fuel may be provided on the upstream side of the fuel injection holes 51. Center axes 51a of the fuel injection holes may be parallel to the center axis 1x of the fuel injection valve, and may be inclined with respect to the center axis 1x of the fuel injection valve. Moreover, the protruding portion 21na may be not provided.

The fuel injection portion 21 arranged to determine a shape of the fuel spray is constituted by the nozzle plate 21n. The valve seat 15 and the fuel injection portion 21 constitute the nozzle section 8 arranged to inject the fuel. The valve element 27c may be considered as a part of components constituting the nozzle section 8.

In this embodiment, the valve element 27c is a ball valve having a spherical shape. Accordingly, the valve element 27c includes a plurality of cutaway surfaces 27ca which are formed at portions confronting the guide surface 15c, and which are positioned at intervals in the circumferential direction. These cutaway surfaces 27ca constitute the fuel passages arranged to supply the fuel to the seat portion. The valve element 27c may be constituted by a member other than the ball valve. For example, the valve element 27c may be a needle valve.

The valve seat member 15 is press-fit in the inner circumference surface 5g of the tip end portion of the cylindrical member 5. Then, the valve seat member 15 is welded and fixed to the cylindrical member 5 by the welding portion 19.

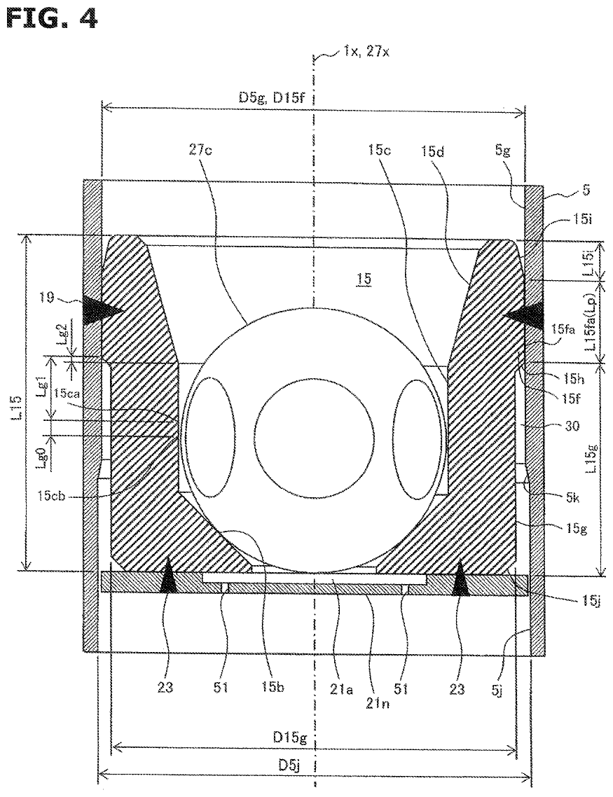

Next, a configuration of the press-fit portion of the valve seat member 15 is explained with reference to FIG. 4. FIG. 4 is a sectional view showing the press-fit portion of the valve seat member 15 according to the one embodiment of the present invention. Besides, FIG. 4 shows a schematic view of the nozzle plate 21n by omitting the protruding portion 21na, and so on. Moreover, a protector 49 arranged to protect the tip end portion of the cylindrical member 5 is omitted. A characteristic portion of the press-fit portion of the valve seat member 15 with respect to the cylindrical member 5 is exaggerated.

The valve seat member 15 has a length L15 in the direction along the center axis 1x. The valve seat member 15 includes the protruding portion 15f protruding in the radially outward direction from the outer circumference surface 15g near the base end side end portion.

The base end side end portion of the protruding portion 15f (that is, the base end side end portion of the valve seat member 15) includes a taper surface 15i having an outside diameter gradually decreased in a conical shape from the tip end side toward the base end side. Moreover, the tip end side end portion of the protruding portion 15f includes a stepped surface 15h. There is a height difference formed by the stepped surface 15h between the outer circumference surface 15fa of the protruding portion 15f, and the outer circumference surface 15g of the valve seat member 15, when viewed in the radial direction of the valve seat member 15.

The taper surface 151 is formed in a range of the length L15i in the direction along the center axis 1x from the base end side end surface of the valve seat member 15. The tip end side end portion of the taper surface 151 is connected to the base end side end portion of the outer circumference surface 15fa of the protruding portion 15f.

The outer circumference surface 15fa of the protruding portion 15f is formed in a range of a length 15fa (Lp) in the direction along the center axis 1x from the tip end side end portion of the taper surface 15i. The tip end side end portion of the outer circumference surface 15fa is connected to one end of the stepped surface 15h.

The outer circumference surface 15g of the valve seat member 15 is formed in a range of a length 15g in the direction of the center axis 1x from the other end of the stepped surface 15h. The outer circumference surface 15g of the valve seat member 15 is formed from the other end of the stepped surface 15h to the tip end side end portion of the valve seat member 15.

Besides, a tamper surface 15j is formed at the tip end side end portion of the outer circumference surface 15g in a range of a small length in the direction along the center axis 1x. The taper surface 15j also serves as a chamfering. In a below explanation, it is considered that the outer circumference surface 15g is formed to extend to the tip end of the valve seat member 15 on the tip end side, in disregard of the taper surface 15j.

An outside diameter D15f of the outer circumference surface 15f of the protruding portion 15f is greater than an outside diameter D15g of the outer circumference surface 15g. Moreover, the outside diameter D15f of the outer circumference surface 15fa is slightly greater than an inside diameter D5g of the inner circumference surface 5g so as to be press-fit in the inner circumference surface 5g of the cylindrical member 5.

On the other hand, an inner circumference portion (inner circumference surface) 5j is formed at the tip end portion of the inner circumference surface 5g of the cylindrical member 5. The inner circumference portion (inner circumference surface) 5j has an increased inside diameter D5j greater than the inside diameter D5g of the inner circumference surface 5g. A taper surface 5k is formed between the inner circumference surface 5g and the inner circumference portion 5j. The taper surface 5k has inside diameters gradually increased from the inner circumference surface 5g toward the inner circumference portion 5j.

With this, when the valve seat member 15 is press-fit in the cylindrical member 5, it is possible to insert the valve seat member 15 from the tip end side to the inner circumference surface 5g of the cylindrical member 5 without abutment with the inner circumference portion 5j which is the inner circumference surface of the cylindrical member 5. The valve seat member 15 starts to receive the press-fit load from when the base end side end portion of the outer circumference surface 15fa of the protruding portion 15f reaches the tip end side end portion of the inner circumference surface 5g of the cylindrical member 5.

In this embodiment, the outer circumference surface 15fa of the protruding portion 15f is the press-fit surface. The outer circumference surface 15fa of the protruding portion 15f is abutted on the inner circumference surface 5g. The press-fit load by the press-fit of the valve seat member 15 with respect to the cylindrical member 5 is acted through the protruding portion 15f to the valve seat member 15.

In this embodiment, an annular clearance 30 is formed between the stepped surface 15h and the outer circumference surface 15g of the valve seat member 15, and the inner circumference surface 5g of the cylindrical member 5. The annular clearance 30 is formed in a range of the length L15g from the tip end side end surface of the valve seat member 15. Accordingly, the press-fit length Lp is determined by the length L15fa of the outer circumference surface 15fa of the protruding portion 15f. The press-fit length Lp can be managed by processing accuracy of the only valve seat member 15.

In FIG. 4, a movable range of the valve element 27 is a range Lg0. A range of the guide surface 15c which is shown by Lg0 is a substantial guide surface arranged to guide the valve element 27c. That is, an upper end portion of the substantial guide surface of the valve element 27c is a portion shown by a symbol 15ca. A lower end portion of the substantial guide surface of the valve element 27c is a portion shown by a symbol 15cb. At the lower end portion 15cb, the guide surface 15c is abutted on the valve element 27c at the valve closing.

In this embodiment, the tip end side end portion of the outer circumference surface 15fa of the protruding portion 15f is positioned on the base end side of the upper end portion 15ca of the substantial guide surface of the valve element 27c by the length Lg1 in the direction along the center axis 1x. That is, the outer circumference surface 15fa of the protruding portion 15f is located at a position apart from the substantial guide surface (the region shown by Lg0) of the valve element 27c on the base end side of the substantial guide surface (the region shown by Lg0) of the valve element 27c in the direction along the center axis 1x. Moreover, this means that the outer circumference surface 15fa of the protruding portion 15f is located at a position apart from the valve seat 15b and the conical surface 15v constituting the valve seat 15b, on the base end side of the valve seat 15b and the conical surface 15v. Accordingly, when the guide surface (region Lg0), the conical surface 15v, and the outer circumference surface 15fa are projected to an imaginary plane parallel to the center axis 1x, the outer circumference surface 15fa is not overlapped with the guide surface (region Lg0) and the conical surface 15v, and the outer circumference surface 15fa is located at a position apart from the conical surface 15v on the base end side of the conical surface 15v. With this, it is possible to suppress the deterioration of the roundness (circularity) of the valve seat 15b and the substantial guide surface (region Lg0) of the valve element 27c due to the press-fit load received at the press-fit.

Moreover, in this embodiment, the tip end side end portion of the outer circumference surface 15fa of the protruding portion 15f is positioned on the base end side of the upper end portion of the guide surface 15c constituting the substantial guide surface (the region Lg0) of the valve element 27c in the direction along the center axis 1x by the length Lg2. That is, the outer circumference surface 15fa of the protruding portion 15f is located at a positon apart from the guide surface 15c on the base end side of the guide surface 15c in the direction along the center axis 1x. With this, it is possible to suppress the deterioration of the roundness (circularity) of the guide surface 15c due to the press-fit load received at the press-fit, and to more effectively suppress the deterioration of the roundness of the substantial guide surface (the region Lg0) of the valve element 27c.

In this embodiment, there is formed the diameter increasing portion (the taper surface) 15d. The outer circumference surface 15fa of the protruding portion 15f is formed on the outer circumference side of the valve seat member 15 in the region in which the diameter increasing portion (the taper surface) 15d is formed.

With this, a thickness of the valve seat member 15 in the outer circumference surface (the press-fit portion) 15fa becomes small. Accordingly, it is possible to stop the deformation generated in the valve seat member 15 at the press-fit, in the diameter increasing portion 15d, and to suppress the influence of the deformation on the guide surface 15c and the conical surface 15v.

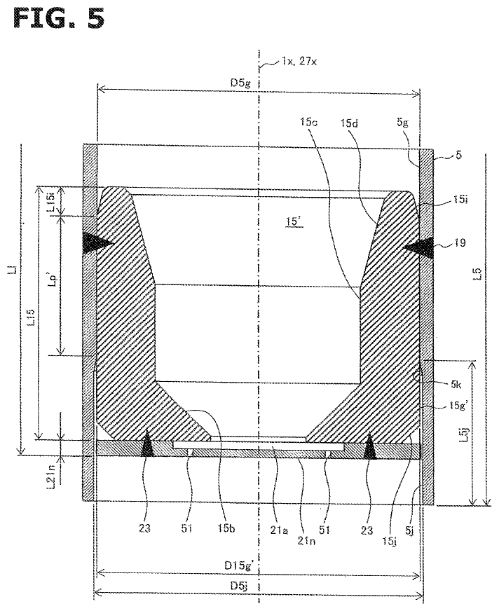

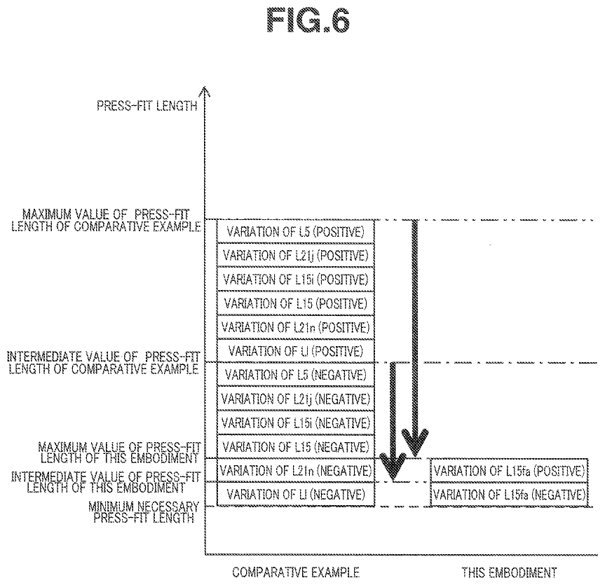

In this case, problems as to setting of the press-fit length are explained with reference to FIG. 5 and FIG. 6.

FIG. 5 is a sectional view showing the press-fit portion of the valve seat member 15 in a comparative example with respect to the present invention. Configurations identical to FIG. 4 have the same symbols as FIG. 4. The repetitive explanations are omitted.

The outer circumference surface 15g′ of the valve seat member 15′ of the comparative example does not includes the protruding portion 15f in this embodiment. The outer circumference surface 15g′ having a constant outside diameter D15g′ is constituted from the lower end portion of the taper surface 15i to the tip end side end surface of the valve seat member 15. The outside diameter D15g′ is slightly greater than the inside diameter D5g of the inner circumference surface 5g so that the valve seat member 15′ can be press-fit in the inner circumference surface 5g of the cylindrical member 5.

In this comparative example, the taper surface 5k and the inner circumference portion 5j having the inside diameter D5j are formed in the tip end portion of the cylindrical member 5. When the valve seat member 15′ is press-fit in the inner circumference surface 5g of the cylindrical member 5, the inner circumference portion 5j and the taper surface 5k serve as an escape portion. Accordingly, in the configuration of the comparative example, the press-fit surface having the press-fit length Lp′ is constituted between the lower end portion of the taper surface 15i of the valve seat member 15′, and the base end side end portion of the taper surface 5k. The press-fit length Lp′ is determined in accordance with a position relationship between the valve seat member 15′ and the cylindrical member 5.

FIG. 6 is a view showing a relationship between size variations of the components, and the press-fit length of the valve seat member 15.

In the comparative example, the press-fit length Lp′ is determined in accordance with the position relationship between the valve seat member 15′ and the cylindrical member 5. The press-fit length Lp′ is influenced by the processing accuracy (size variation) of the valve seat member 15′, the processing accuracy (the size variation) of the cylindrical member 5, and the assembly accuracy of the valve seat member 15′ and the cylindrical member 5. Accordingly, it is necessary to consider (1) the variation of the press-fit position LI of the valve seat member 15, (2) the variation of the size L21n of the nozzle plate 21n, (3) the variation of the entire length L15 of the valve seat member 15, (4) the variation of the size L15i of the taper surface 15i of the valve seat member 15, (5) the variation of the taper surface 5k and the inner circumference portion 5j of the cylindrical member 5, and (6) the variation of the entire length L5 of the cylindrical member 5, with respect to a minimum necessary press-fit length.

In the above-described variations (1) to (6), in FIG. 6, (positive) is attached to the variation deviated from an intermediate value on the positive side. Moreover, (negative) is attached to the variation deviated from the intermediate value on the negative side.

As shown in FIG. 6, in the comparative example, it is necessary to determine the press-fit length Lp′ by accumulating the positive and negative variation amounts (1) to (6) with respect to the minimum necessary length. Accordingly, the press-fit length p′ becomes a length shown by “press-fit maximum value of comparative example”.

On the other hand, in this embodiment, the press-fit length Lp is determined in accordance with the length L15fa of the outer circumference surface 15fa of the protruding portion 15f. It is possible to manage the press-fit length Lp by the processing accuracy of the only valve seat member 15. Accordingly, for the press-fit length Lp, it is necessary to consider the influence of only (7) the variation of the length L15fa of the protruding portion outer circumference surface 15fa of the valve seat member 15, with respect to the minimum necessary press-fit length. Consequently, the press-fit length Lp is determined by accumulating the positive and negative variation amounts with respect to the intermediate value, to the minimum necessary press-fit length. The press-fit length Lp of this embodiment becomes a length shown by “maximum value of press-fit length”, The press-fit length LP can be remarkably shortened relative to the length shown by “maximum value of press-fit length of comparative example”.

For suppressing the deterioration of the roundness of the guide portions (the upper end portion 15ca, the lower end portion 15cb, and the guide surface 15c), and the valve seat 15b at the press-fit of the valve seat member 15 in the cylindrical member 5, it is preferable to shorten the press-fit lengths Lp and Lp′, and to decrease the press-fit load acted to the valve seat members 15 and 15′. In this embodiment, it is possible to shorten the press-fit length Lp as described above, and thereby to decrease the press-fit load acted to the valve seat member 15. Moreover, in this embodiment, it is possible to suppress the deterioration of the roundness of the valve seat 15b and the guide portions (the upper end portion 15ca, the lower end portion 15cb, and the guide surface 15c) at the press-fit of the valve seat member 15 in the cylindrical member 5, and to improve oil-tight characteristic of the seal portions of the valve element 27c and the valve seat 15b.

Next, a variation according to this embodiment is explained.

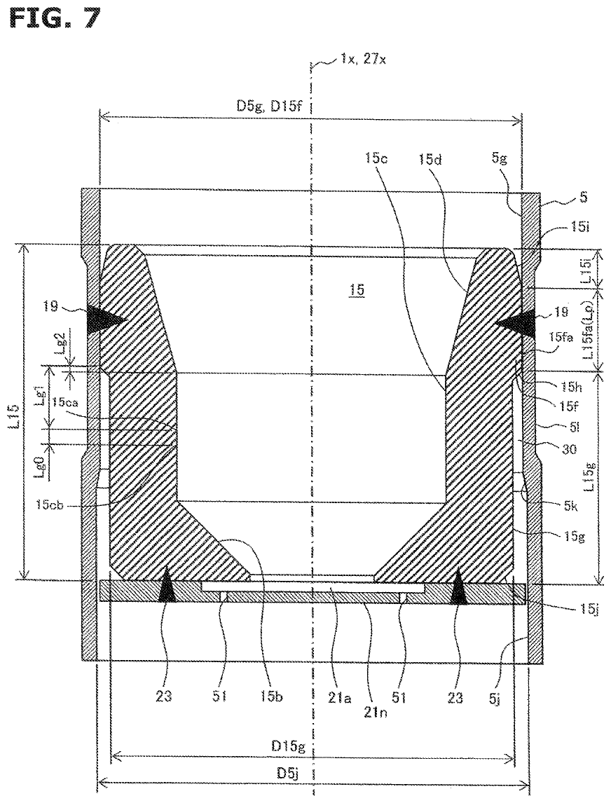

FIG. 7 is a sectional view showing a press-fit portion of the valve seat member 15 according to the variation (first variation) of the embodiment of the present invention. Configurations identical to the above-described embodiment have the same symbols as the above-described embodiment. The repetitive explanations are omitted. Moreover, configurations which are other than the below-described configuration are identical to the configuration of the above-described embodiment.

In this variation, an annular groove 51 is formed on the outer circumference surface of the cylindrical member 5. A thickness of the cylindrical member 5 is thinned by forming the annular groove 51. The annular groove 51 is formed at a portion which includes the welding portion 19, and which is near the welding portion 19. The annular groove 51 does not reach the tip end portion of the cylindrical member 5.

In this variation, a thickness of the cylindrical member 5 at the welding portion 19 is smaller than a thickness of the cylindrical member 5 on the base end side. Accordingly, it is possible to decrease the heat input amount at the welding, and to suppress the deformation of the conical surface 15v and the guide surface 15c due to the heat input.

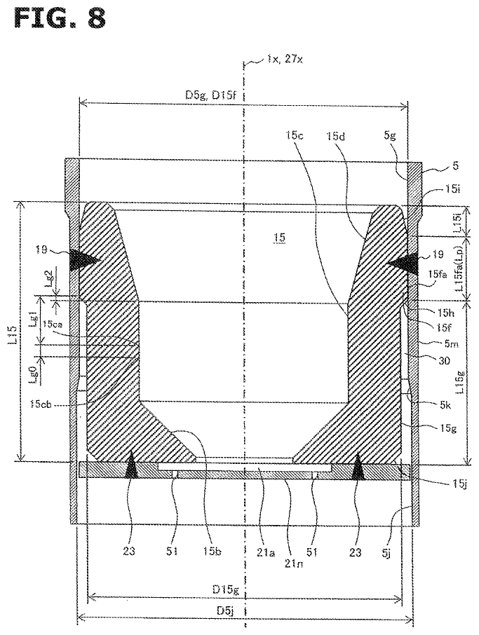

FIG. 8 is a sectional view showing a press-fit portion of the valve seat member 15 according to the variation (second variation) of the embodiment of the present invention. Configurations identical to the above-described embodiment have the same symbols as the above-described embodiment. The repetitive explanations are omitted. Moreover, configurations which are other than the below-described configuration are identical to the configuration of the above-described embodiment.

In this variation, the annular groove 51 according to the first variation extends to the tip end portion of the cylindrical member 5. The thickness of the cylindrical member 5 from the portion including the welding portion 19 to the tip end portion is thinned than the thickness of the cylindrical member 5 on the base end side. That is, in this variation, the cylindrical member 5 includes a small thickness portion 5m which is formed in a range from the portion including the welding portion 19 to the tip end portion, and which has an outside diameter smaller than that of the base end side. In this embodiment, it is also possible to attain the same effects as the first variation.

Besides, a plurality of the press-fit portions which are constituted by the above-described protruding portions 15f may be provided in the direction along the center axis 1x, although the protruding portion located at the tip end satisfies the disposition conditions of the above-described protruding portion 15f.

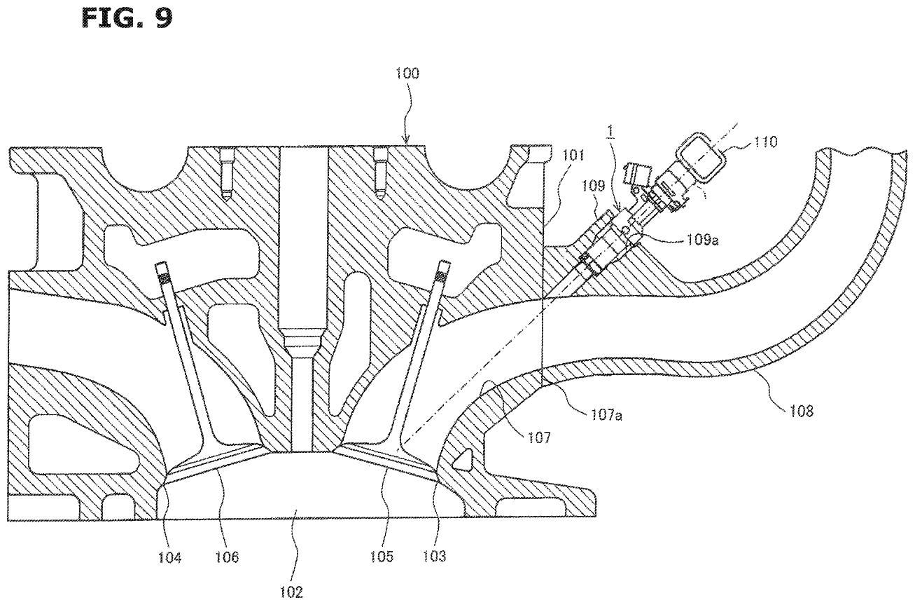

The internal combustion engine to which the fuel injection valve according to the present invention is mounted is explained with reference to FIG. 9. FIG. 9 is a sectional view of the internal combustion engine to which the fuel injection valve 1 is mounted.

An engine block 101 of the internal combustion engine 100 includes a cylinder 102. An intake opening 103 and an exhaust opening 104 are provided on a top portion of the cylinder 102. An intake valve 105 arranged to open and close the intake opening 103 is provided to the intake opening 103. An exhaust valve 106 arranged to open and close the exhaust opening 104 is provided to the exhaust opening 104. The engine block 101 includes an intake flow passage 107 connected to the intake opening 103. The intake flow passage 107 includes an inlet side end portion 107a connected to an intake pipe 108.

A fuel pipe 110 is connected to the fuel supply opening 2 (cf. FIG. 1) of the fuel injection valve 1.

The intake pipe 108 includes a mounting portion 109 for the fuel injection valve 1. The mounting portion 109 includes an insertion opening 109a to which the fuel injection valve 1 is inserted. The insertion opening 109a penetrates to an inner wall surface (intake flow passage) of the intake pipe 108. The fuel injected from the fuel injection valve 1 inserted into the insertion opening 109a is injected into the intake flow passage. In case of two directional spray, in the internal combustion engine in which two intake openings 103 are provided to the engine block 101, the respective fuel sprays are directed and injected to the respective intake openings 103 (the intake valves 105).

Besides, the present invention is not limited to the above described embodiment and variation. It is optional to delete a part of the configuration, and to add other configuration which is not described.

For example, below-described aspects are conceivable as the fuel injection valves based on the above-described embodiment.

In one aspect, a fuel injection valve includes: a valve seat and a valve element which are cooperated to open and close a fuel passage; a valve seat member to which the valve seat and a guide surface arranged to guide the valve element are formed; and a cylindrical member including an end portion which is on a tip end side, and in which the valve seat member is press-fit, the valve seat member including a press-fit portion which is press-fit in the cylindrical member, and which is located at a position apart from the valve seat and the guide surface on a base end side of the valve seat and the guide surface in a direction along a center axis of the fuel injection valve.

In a preferable aspect of the fuel injection valve, the press-fit portion is constituted by a protruding portion which protrudes from an outer circumference surface of the valve seat member in a radially outward direction, and which has an annular shape along the outer circumference surface.

In another preferable aspect, in one of the aspects of the fuel injection valve, the valve seat member includes a taper surface which has inside diameters becoming greater from the tip end side toward the base end side of the cylindrical member with respect to the guide surface; and an outer circumference surface of the protruding portion is formed on the outer circumference side of the valve seat member in a range in which the taper surface is formed.

In another preferable aspect, in one of the aspects of the fuel injection valve, a clearance is formed between an inner circumference surface of the cylindrical member, and an outer circumference surface of the valve seat member between an end surface on the tip end side of the cylindrical member, and an end portion of the press-fit portion on the tip end side.

In another preferable aspect, in one of the aspects of the fuel injection valve, the cylindrical member includes a small thickness portion which is located on the outer circumference side of a portion abutted on the press-fit protruding portion, and which has a thickness smaller than a thickness of the base end side; and the cylindrical member and the valve seat member are welded to each other at the small thickness portion.

1. A fuel injection valve comprising:
a valve seat and a valve element which are cooperated to open and close a fuel passage;
a valve seat member to which the valve seat and a guide surface arranged to guide the valve element are formed; and
a cylindrical member including an end portion which is on a tip end side, and in which the valve seat member is press-fit,
the valve seat member including a press-fit portion which is press-fit in the cylindrical member, and which is located at a position apart from the valve seat and the guide surface on a base end side of the valve seat and the guide surface in a direction along a center axis of the fuel injection valve.

2. The fuel injection valve as claimed in claim 1, wherein the press-fit portion is constituted by a protruding portion which protrudes from an outer circumference surface of the valve seat member in a radially outward direction, and which has an annular shape along the outer circumference surface.

3. The fuel injection valve as claimed in claim 2, wherein the valve seat member includes a taper surface which has inside diameters becoming greater from the tip end side toward the base end side of the cylindrical member with respect to the guide surface; and
an outer circumference surface of the protruding portion is formed on the outer circumference side of the valve seat member in a range in which the taper surface is formed.

4. The fuel injection valve as claimed in claim 3, wherein a clearance is formed between an inner circumference surface of the cylindrical member, and an outer circumference surface of the valve seat member between an end surface on the tip end side of the cylindrical member, and an end portion of the press-fit portion on the tip end side.

5. The fuel injection valve as claimed in claim 4, wherein the cylindrical member includes a small thickness portion which is located on the outer circumference side of a portion abutted on the press-fit protruding portion, and which has a thickness smaller than a thickness of the base end side; and
the cylindrical member and the valve seat member are welded to each other at the small thickness portion.
